(19) United States
(12) Patent Application Publication
(10) Pub. No.: US 2006/0033323 A1
(43) Pub. Date: Feb. 16, 2006

(54) System and method for generating a uniform price tag

(76) Inventor: Steve Reynolds, Carson City, NV (US)

Correspondence Address: VIRTUAL LEGAL, P.C.;MICHAEL A. KERR, 3476 EXECUTIVE POINTE WAY, UNIT 16, CARSON CITY, NV, 89706, US

(21) Appl. No.: 10/870,703

(22) Filed: Jun. 16, 2004

(51) Int. Cl. B42D 15/00; G06Q 20/00

(52) U.S. Cl. 283/55; 705/20

(57) ABSTRACT

A system and method for generating a uniform price tag for a retailer. The retailer configures a price tag by providing retailer information. The system and method includes a searchable and updated database that has product information. The retailer performs a search of the database and selects at least one product from the database. The uniform price tag is a price tag that comprises selected product information and retailer information.

### CROSS REFERENCE

This patent application is related to provisional patent application Ser. No. 60/478,965 which is hereby incorporated by reference. The provisional patent application was filed on Jun. 16, 2003.

### BACKGROUND

1. Field

The invention is related to a system and method of generating a uniform price tag for a retailer's products. More particularly, the invention is related to generating a uniform price tag for a retail store.

2. Description of Related Art

Independent retailers have a limited number of ways to generate price tags for their products. Unlike large “box” stores, independent retailers do not have simple tools for generating a uniform price tag that includes both product information and retailer information. Currently, independent retailers' only have a limited number of ways to generate price tags. The first technique for generating a price tag is to create hand written price tags. Hand written price tags do not have a professional appearance and have been shown to affect sales. In order to overcome the limitations associated with hand written price tags, some retailers generate computerized price tags using word processors, spreadsheet programs, or graphics programs. Generating price tags using these software tools is time consuming and does not produce consistent results.

The process of generating a price tag is a time-consuming proposition because a substantial amount of time is spent looking up product information in manufacturer catalogs. The typical product information that is researched by the retailer includes pricing information, product feature information, and other factors such as the available color for an appliance.

Furthermore, the retailer is likely to make mistakes during the process of generating a price tag because of errors in the transcription process. Typically, these transcription errors affect the retailer's profitability.

Although inventory control programs are well known, inventory control programs do not permit the retailer to generate price tags. Additionally, it is difficult for the retailer to keep track of rebates. Rebates include manufacturer rebates, national rebates, local rebates, and retailer “instant” rebates.

### SUMMARY

A method for generating a uniform price tag for a retailer comprising causing the retailer to configure a retailer database by providing a plurality of retailer information. The retailer database is a searchable database that has a plurality of product information stored thereon. The method permits the retailer to be updated periodically. The retailer is permitted to select at least one product from the database. The uniform price tag is generated by combining the product information with the retailer information on the price tag.

The system that generates the uniform price tag for the retailer comprises a a server having a product database, a personal computer, and a printer operatively coupled to the personal computer. The server stores updated product information and has a network connection to the Internet. The personal computer is communicatively coupled to the Internet. The personal computer has a retailer database that is configured to store retailer information and product information downloaded from the server. The retailer database permits the retailer to search the database to select a product, and retrieve product information. The printer is in operative communication with the personal computer. The printer is configured to print the uniform price tag for one or more selected products. The uniform price tag comprises product information and retailer information extracted from the retailer database.

The personal computer configured to generate a uniform price tag for a retailer comprises a memory, a network connection, a processor, and a printer. The memory has a searchable retailer database stored thereon that receives product information, and retailer information. The network connection is configured to allow updating the retailer database with product information. The processor is operatively coupled to the memory. The processor is configured to permit the retailer to search the retailer database to select a product, and retrieve product information. The printer is configured to print the uniform price tag for the selected product.

### BRIEF DESCRIPTION OF THE DRAWINGS

Embodiments for the following description are shown in the following drawings:

FIG. 1 is an illustrative system diagram for generating the uniform price tag.

FIG. 2 is an illustrative diagram of the personal computer that is configured to generate the uniform price tag.

FIG. 3 is an illustrative price tag.

FIG. 4 is a flowchart with a general overview for the method of generated a price tag.

FIG. 5 is a flowchart of the retailer configuring the systems and methods for generating a price tag by providing specific information about the retailer's store.

FIG. 6 is an illustrative screenshot of the retailer's configuration GUI.

FIG. 7 is a flowchart that shows how an illustrative database is updated.

FIG. 8 is an illustrative screenshot showing the update status for the database.

FIG. 9 is a flowchart for performing a product search.

FIG. 10 is an illustrative screenshot after completing a category based product search.

FIG. 11A and 11B is a flowchart for generating the uniform price tag.

FIG. 11C is an illustrative screenshot of the GUI that is used to generate the uniform price tag.

FIG. 12 is a screenshot of the GUI for generating a Custom Tag.

FIG. 13 is a screenshot of the GUI for generating a quote for a plurality of the retailer's products.

### DESCRIPTION

In the following detailed description, reference is made to the accompanying drawings, which form a part hereof, and in which show by way of illustration specific embodiments in which the invention may be practiced. These embodiments are described in sufficient detail to enable those skilled in the art to practice the invention, and it is to be understood that other embodiments may be utilized and that structural and logical changes may be made without departing from the spirit and scope of the claims. The following detailed description is, therefore, not to be taken in a limited sense.

The systems and methods described herein permits retailer's to create custom price tags. Generally, printed price tags enhance a retailer's ability to make a selling price less negotiable. Since printed price tags are normally only found in large “big box” retail outlets, the professional appearance of the independent retailer's price tag helps a small retailer close a sale. The price tags described herein can be generated quickly and include updated product information. The retailer can obtain product information using a variety of different search tools. The price tag can be customized in a variety of different ways as described in further detail below.

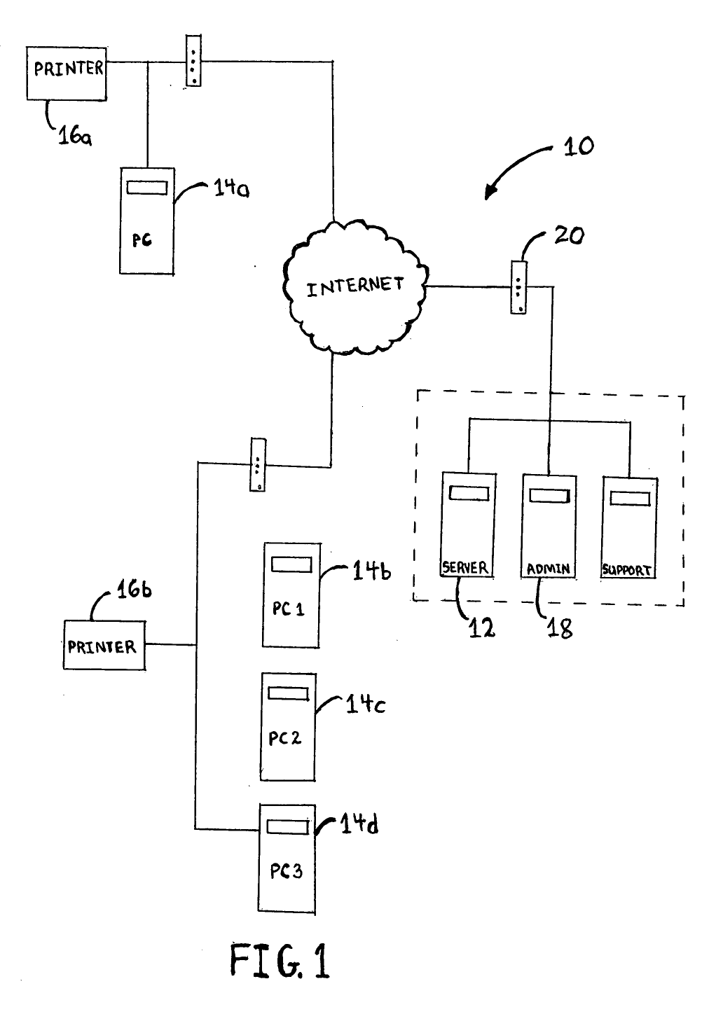

Referring to FIG. 1 there is shown an illustrative system diagram 10 for generating the uniform price tag. The system 10 that generates the uniform price tag for the retailer comprises a product database stored on server 12, personal computers 14a-14d, and printers 16a, 16b. The product database stored on server 12 receives updated product information from the Admin client 18. The server 12 has a network connection to the Internet via gateway 20. Each of the personal computers 14a through 14d are communicatively coupled to the Internet. In the illustrative embodiment, the product database on server 12 is downloaded to stand-alone client 14a, and one of the clients on the network, e.g. personal computer 14b.

Both the stand-alone client 14a and the networked computers 14b through 14d are configured to store retailer information on a retailer database. By way of example, the retailer database is resident on a stand-alone client 14a, and networked client 14b. The retailer database also includes product information downloaded from the product database stored on server 12. The retailer database includes product information associated with products sold by the retailer and retailer information including the retailer's name and address. Additionally, the retailer's information may include the retailer's store logo and/or retailer's affiliation with a buying group or promotional group. In operation, the retailer searches the locally stored database to select a product, and retrieve product information. The product information includes pricing information and rebate information from one or more rebate programs.

The locally stored retailer database permits the retailer to generate a product number or SKU number that is correlated to a model number for the selected product. A model number is used y a manufacturer to identify its products. The product number is displayed on the uniform price tag, and the model number is not displayed on the price tag. The locally stored retailer database tracks the product number/SKU number so that retailer can search for the product using either the product number/SKU number. The model number is hidden from the price tag so that the independent retailer can more effectively compete with the large “box” stores. The model number is used by retail stores to identify manufactured products, and thereby determine pricing for the model number. Without a model number, a customer cannot easily compare one retail product such as an appliance from one retail store with the same appliance at another retail store.

The printers 16a and 16b are in operative communication with either the stand-alone client or the networked clients, respectively. Each of the printers is configured to print the uniform price tag for one or more selected products. The uniform price tag comprises product information and retailer information extracted from the retailer database. Additionally, the uniform price tag can be configured to display a plurality of prices on the price tag. For example for the same refrigerator model, a first price may be associated with a stainless steel refrigerator and a second price tag may be associated with a white enamel refrigerator.

It shall be appreciated by those skilled in the art having the benefit of this disclosure that the systems and methods described herein can be implemented on a variety of platforms including by not limited to the Windows' platforms, Linux/Unix platforms and other such platforms. Additionally, a variety of different personal computer systems and architectures may be configured to perform the functions described.

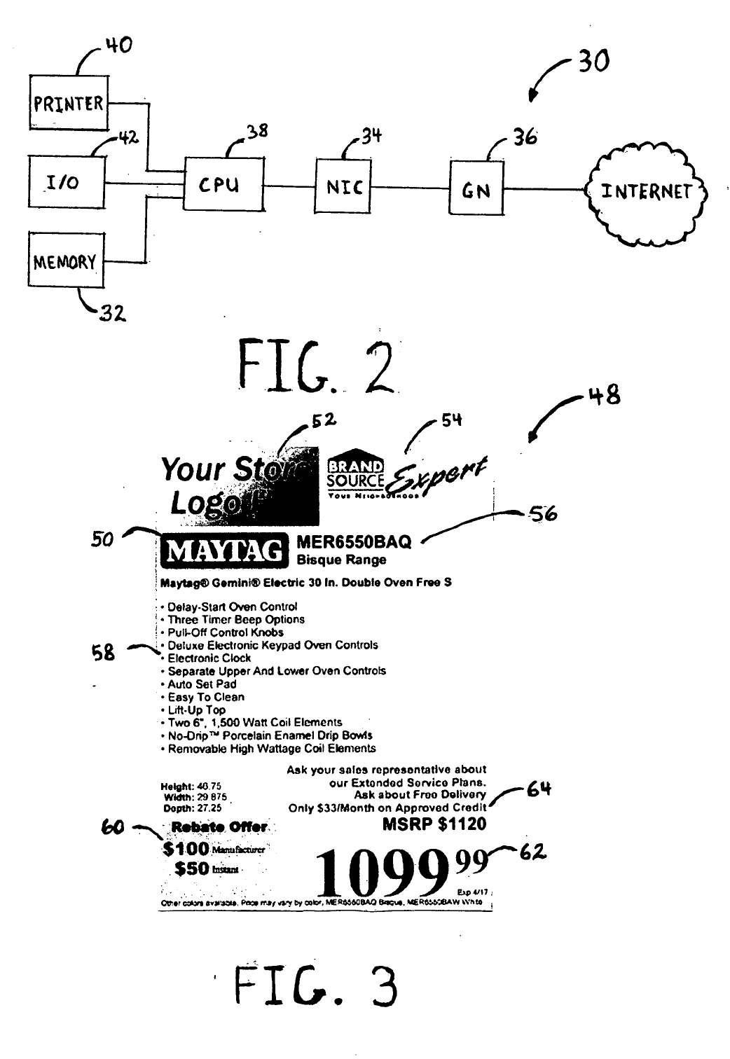

Referring to FIG. 2 there is shown an illustrative diagram of the personal computer 30 that is configured to generate the uniform price tag. The personal computer 30 comprises a memory 32, a network connection that includes a network interface card (NIC) 34 and a gateway 36 that supports an illustrative broadband connection, a processor 38, a printer 40, and an input device 42. The input/output device 42 includes a keyboard, a mouse, and a display that shows a user interface. The user interface permits the retailer to select a desired product and determine the price for the selected product.

For the stand-alone client 14a, or the local client 14b having the retailer database stored thereon, the memory 32 stores the searchable retailer database having product information and retailer information. The network connection, which includes the NIC 34 and the gateway 36, permits the personal computer to receive updates from the server 12 having the updated product information described in FIG. 1. The processor 38 is operatively coupled to the memory 32. The processor 38 is configured to permit the retailer to search the retailer database, select a product, retrieve product information, and combine the product information with the retailer's information in the price tag.

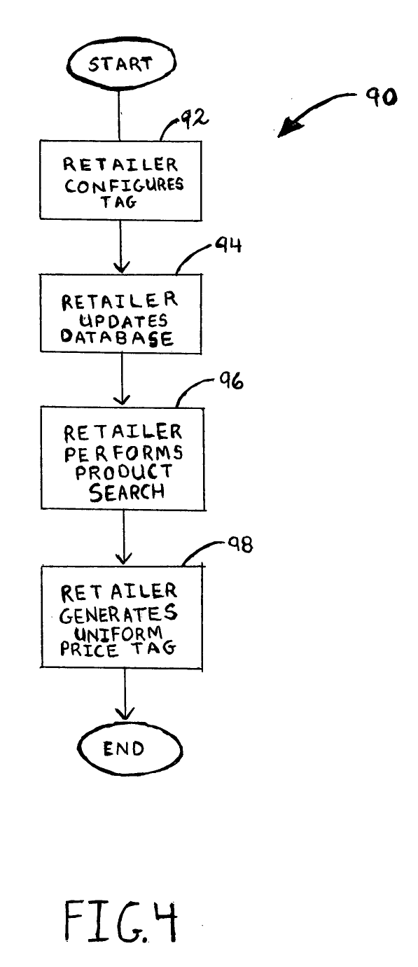

Referring to FIG. 3, there is shown an illustrative price tag 48 that is generated with the systems and methods described herein. The illustrative price tag 48 is for an independent retail store that sells appliances such as ranges and ovens. The illustrative price tag 48 displays inter alia brand logo 50, retailer's logo 52, buying group logo 54, SKU number 56, “features” 58 that describe the product, colors available for the model number (not shown), rebates 60 such as manufacturer rebate and/or instant rebate, energy star logo (not shown), sale price 62, and financing information 64.

Additionally, the systems and methods described herein permit the retailer to use the locally stored retailer database to store and manage additional information that includes inter alia dealer cost, minimum sales price, retailer's rebates, energy star rebates for retailer's area which are displayed on the price tag, and extended warranty prompts for the customer. Furthermore, the systems and methods described herein permit the retailer to quickly look up additional features on any model using locally stored information and/or information provided on a web site. It shall be appreciated by those skilled in the art having the benefit of this disclosure that similar systems and methods may be adapted to a variety of other retail stores including but not limited to independent retail stores, electronics' stores, independent electronic stores, and other such stores.

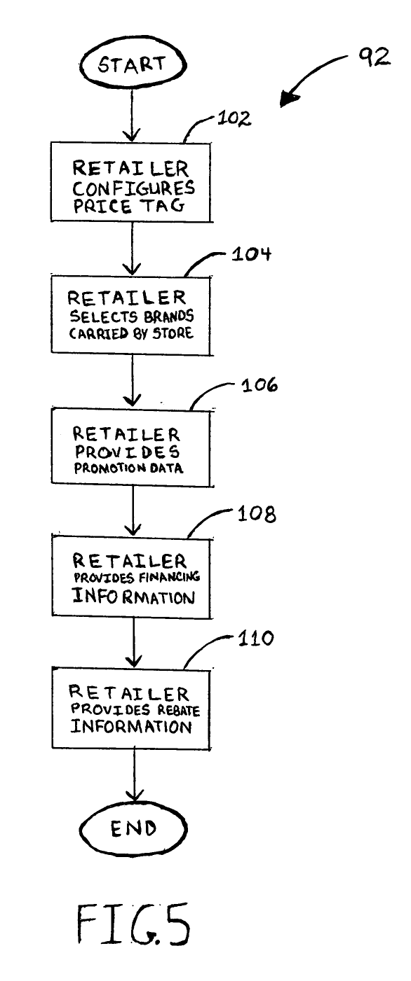

Referring to FIG. 4 there is shown a flowchart with a general overview for the method of generated a price tag. The method is initiated at block 92 by causing the retailer to provide the retailer's particular information to properly configure the retailer database. At block 94, the method proceeds to either download an updated database with product information or update the locally stored retailer database. At block 96, the retailer performs a search of the retailer database and selects at least one product from the updated retailer database. The retailer may then select product information from the retailer database to include on the price tag. The retailer may also manipulate the retailer database with information that is specific to the retailer such as generating a SKU number that is correlated to a model number for the selected product, wherein only the SKU number is displayed on the uniform price tag. At block 98, the method proceeds to generate the uniform price tag by combining inter alia selected product information and retailer information. Additionally, the retailer can identify one or more rebates on the uniform price tag. Furthermore, the retailer may generate the uniform price tag that displays a plurality of prices for the product number such as manufacturer's suggested retail price (MSRP), the retailer's price, the retailer's price for an alternative color, and/or the price with financing.

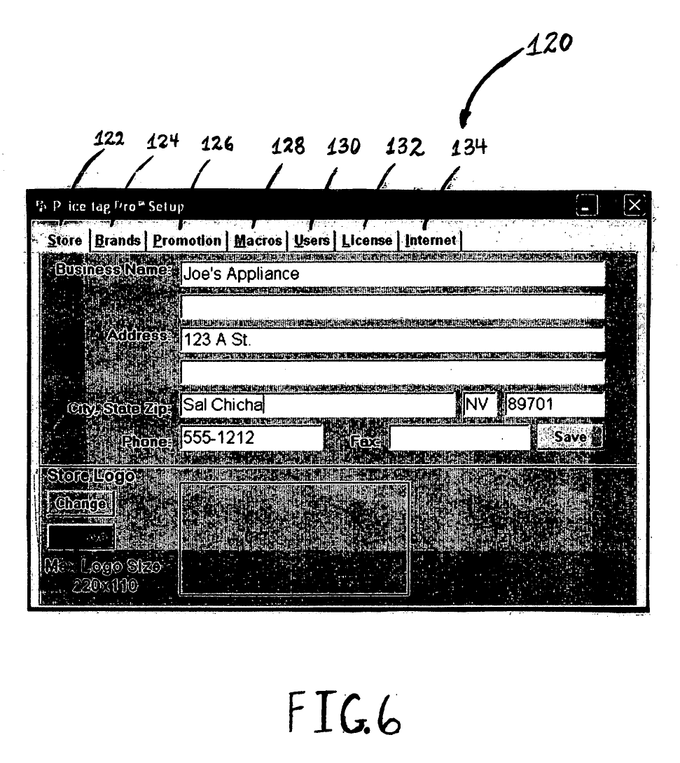

Referring to FIG. 5, the retailer configures the price tag or more specifically the retailer database by having the retailer provide specific information about the retailer as described above in block 92. In the illustrative embodiment, at block 102 the retailer provides specific information about the retailer's store such as the retailer's: name, logo, address, phone, and fax information. The illustrative embodiment then continues to block 104 where the retailer selects “brands” that are carried by the retailer's store. In the illustrative embodiment, the term “brands” refers to brand name appliances and/or electronics sold by the retailer. Thus the product information updates for the retailer database are limited to brands that are carried by the retailer. At block 106 of the illustrative embodiment, the retailer is prompted to provide promotional logo information. The illustrative embodiment then continues to block 108, in which the retailer's financing formula is provided so that the price tag may include pricing using this financing information. Additionally, the illustrative embodiment prompts the retailer for rebate information such as “Energy Star” rebates or instant rebates granted to the customer.

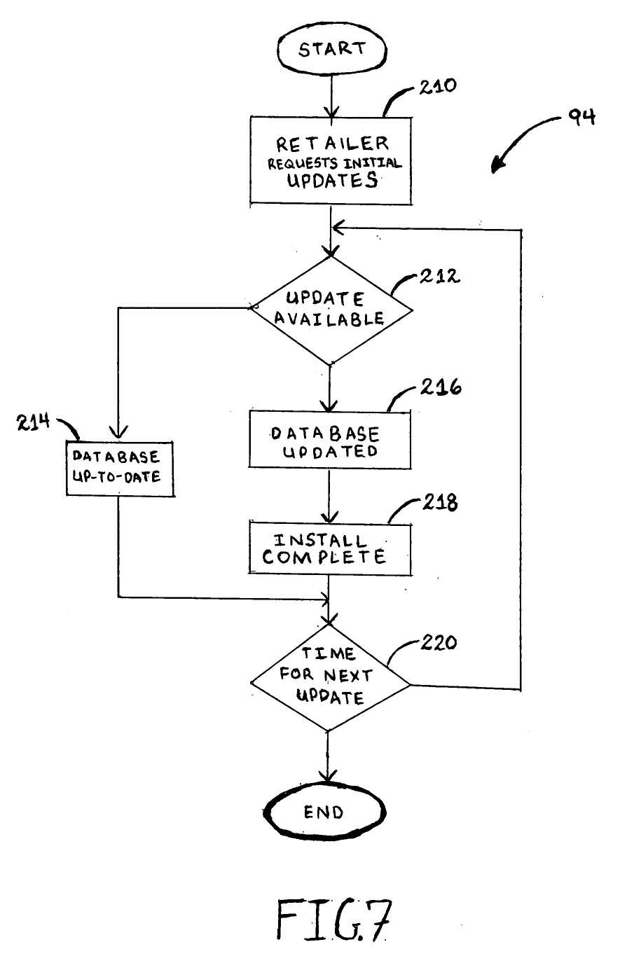

Referring to FIG. 6, there is shown an illustrative screenshot 120 of GUI that permits the retailer to input particular retailer information into the retailer database. The first tab 122 requests that the retailer input information such as the retailer's name, address, city, and phone number. Additionally, the retailer can input a store logo. A second tab 124 entitled “brands” permits the retailer to identify the brands carried by the retailer's store. The third tab 126 is entitled “promotions” permits the retailer to input rebate information, a promotion logo, and a financing formula. The macros tab 128 permits the retailer to configure macros for the program. The users tab 130 identifies the users that are authorized to use the software. The license tab 132 describes the terms of the license agreement for use of the software. The Internet tab 134 provides a number of different methods to configure the program to interface with a network connection that is communicatively coupled to the Internet.

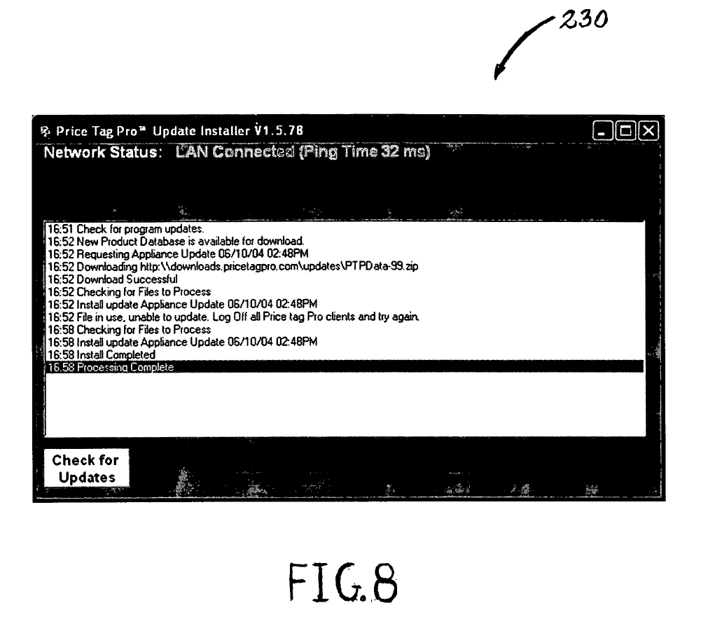

Referring to FIG. 7 there is shown a flowchart of how an illustrative retailer database, which is stored locally, is updated. At block 210, the retailer requests an initial update that populates the retailer database with specific information about a group of products such as particular appliances. The product information is downloaded from a server 12 having an updated database of product information as described above. At diamond 212, the determination is made whether another update is necessary. If the decision is that no update is necessary, then the update process proceeds to block 214 where the client is informed that the product database is up-to-date. If the decision at diamond 212 is that an update is necessary, the method proceeds to update the database at block 216. At block 218, the retail client is informed that the update has been installed. At decision diamond 220, a timer is evaluated to determine when the next update is scheduled.

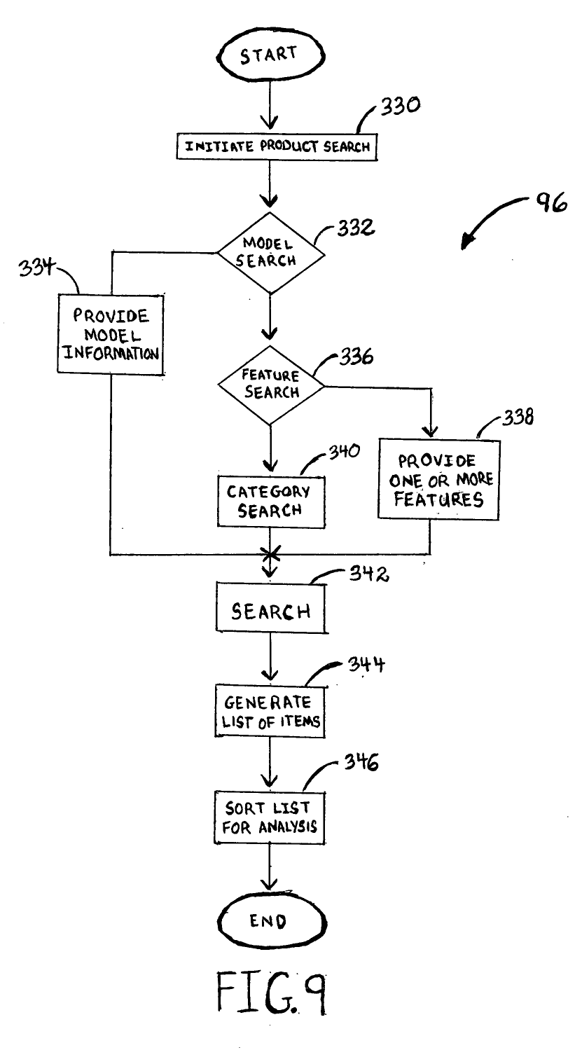

Referring to FIG. 8 there is shown a screenshot 230 that reflects the update status for the database. The update status for the local database shows that a new product database is available for download, that the download was successful, and the installation of the update was successful. The update process can occur manually or automatically. Typically, automatic updates are performed by initiating the updating process at predetermined times and/or dates.

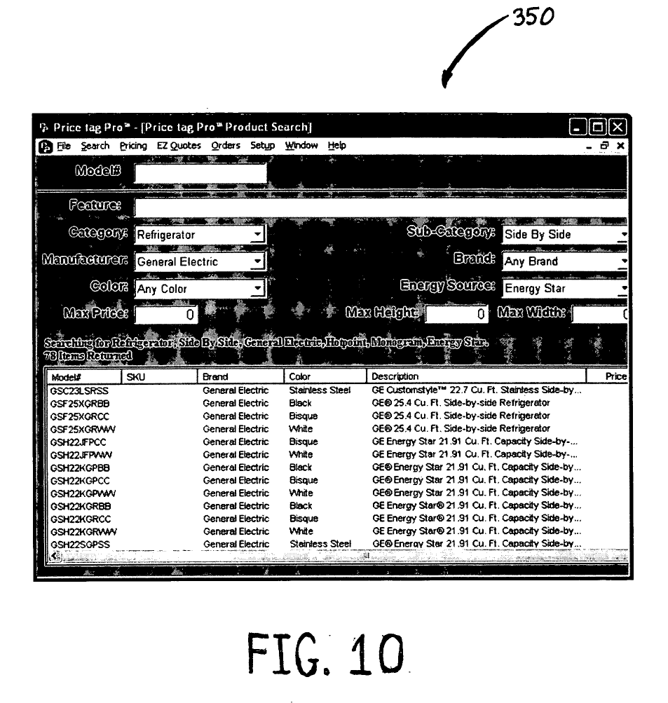

Referring to FIG. 9 there is shown a flowchart for performing an illustrative product search described in block 96 above. The product search is initiated at block 330 by opening the product search window. A determination is then made at decision diamond 332 to perform a model search. In the illustrative embodiment, if a model search is performed, the search entails entering a specific model number in the model field as described in block 334. Depending on the type of model number, the model's price or multiple models will be displayed. In the illustrative embodiment, the model search permits a search of the retailer database which contains thousands of model numbers, including but not limited to, model number, brand, category, color, energy type, and price.

If the decision at diamond 332 is to not perform a model search, the retailer may decide to perform a feature search at decision diamond 336. If the retailer decides to perform a feature search, then the retailer proceeds to block 338 where the retailer inputs specific feature terms in a text field. The retailer may decide not to perform either a model search or a feature search, and instead perform a category search. The category search is initiated at block 340, in which the retailer chooses product categories from drop-down menus, and the retailer proceeds to refine the search by selecting additional criteria such as sub-category, manufacturer, brand, color, energy source, max price and max width. Depending on which of the three illustrative searches is selected, a search is then performed at block 342. Subsequently, a list is generated and displayed as shown in block 344. In the illustrative embodiment, at block 146, the retailer then has an opportunity to sort the list from block 344 according to a variety of parameters as is well known in the art.

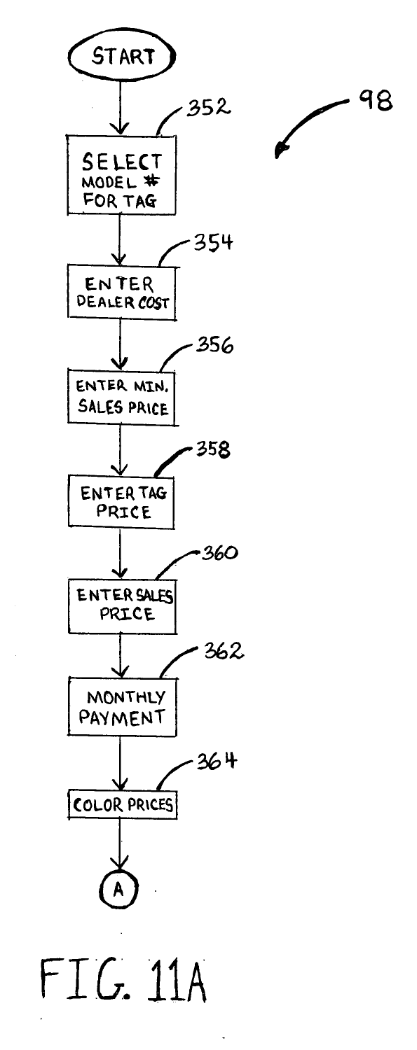

Referring to FIG. 10 there is shown an illustrative screenshot 350 generated after completing an illustrative category based search. The illustrative category selected was for a “refrigerator”. The selected manufacturer was “General Electric” and the sub-category was “side-by-side”. The brand field was left open. The results of the category search are reflected at the bottom of the screenshot.

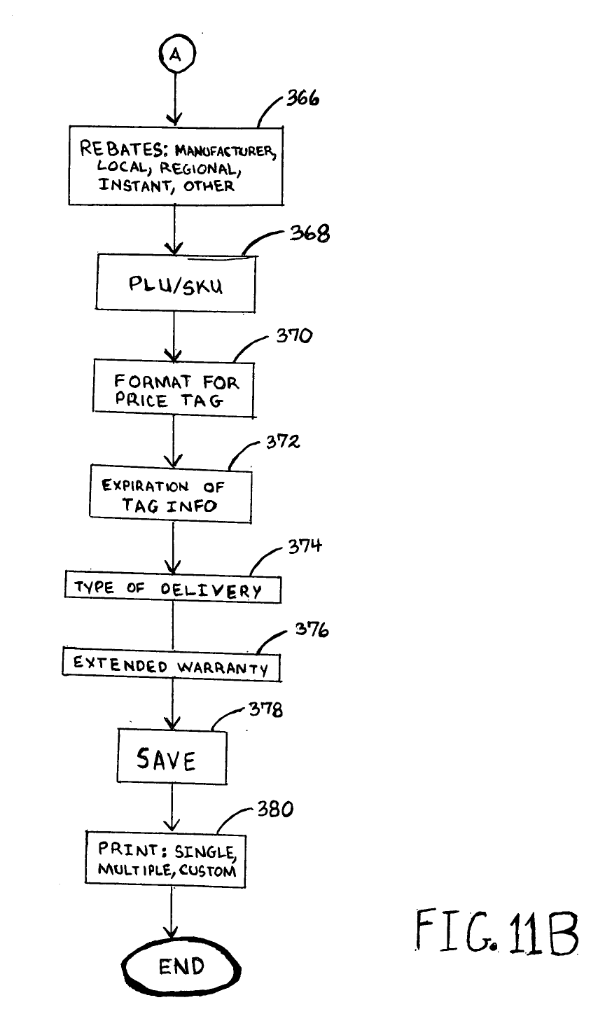

Referring to FIG. 11A and 11B, there is shown the method for pricing the retailer's selected product as described in block 98 above. At block 352, the retailer selects a model number for a product. The model number is used to obtain product information that is incorporated into the uniform price tag. At block 354, the retailer enters the dealer cost which is the retailer's cost for the product. In one embodiment, if the dealer cost is entered and the customary tag price is known, an automatic margin calculator may be used to automatically generate a tag price. The tag price is the price that is printed on the price tag, and is also used for price searching and for generating quotations. At block 356, the retailer enters the minimum sales price which is the lowest price at which an item can be quoted to a customer. At block 358, the tag price may be entered manually. At block 360, the sales price is entered. The sales price is the price when the selected product is “on sale.” At block 362, the monthly payment field automatically lists the monthly payment price for the selected product based on the financing formula described above in the configuration process. At block 364, the prices for different color models are provided.

Referring now to FIG. 11B the method of generating a uniform price tag continues in block 366 where rebate information is provided. The rebate information includes manufacturer rebate programs. If a manufacturer rebate is available, the value and expiration is also displayed. Local and regional rebates may also be provided. At block 368, the PLU/SKU information is input wherein the PLU/SKU information is printed on the price tag in place of the product model number. At block 370, the price tag is formatted for printing in 5″×7″ portrait price tags or 8.5″×11″ landscape price tags. At block 372, the expiration date for the price tag is provided. At block 374, the type of delivery is identified, i.e. free delivery or charge delivery. At block 376, the availability of an extended warranty is identified. At block 378, the input information is saved and the local database is updated with this additional information. At block 380, the price tag is printed. The type of price tags that may be printed include a single price tag for a single product, multiple price tags for multiple products, or custom price tags for products not identified in the database.

Referring to FIG. 11C there is shown a screenshot for GUI used to generate the uniform price tag. The illustrative screenshot includes specific information related to the product as described above. Additionally, the illustrative screenshot displays a link 384 to the World Wide Web, which links the retailer directly to a web page that provides additional information about the selected product. Typically, the web page is generated by the manufacturer.

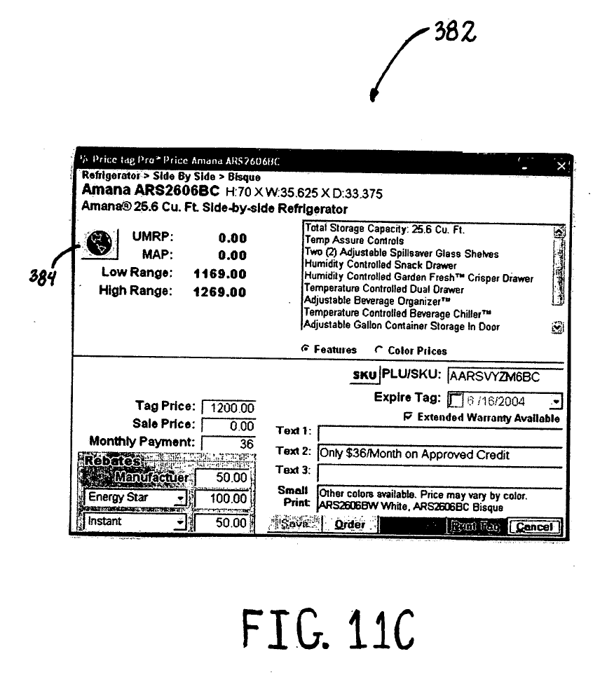

Referring to FIG. 12 there is shown a screenshot 390 of the GUI for generating a custom tag. The custom tag is a price tag that is generated without using information stored on the product database. The custom tag permits the retailer to produce a professional tag for products not identified in the locally stored database. The custom price tag provides a group of blank fields that are similar to the fields described above. The customized tag information is stored on the retailer database and may be revised at a later time.

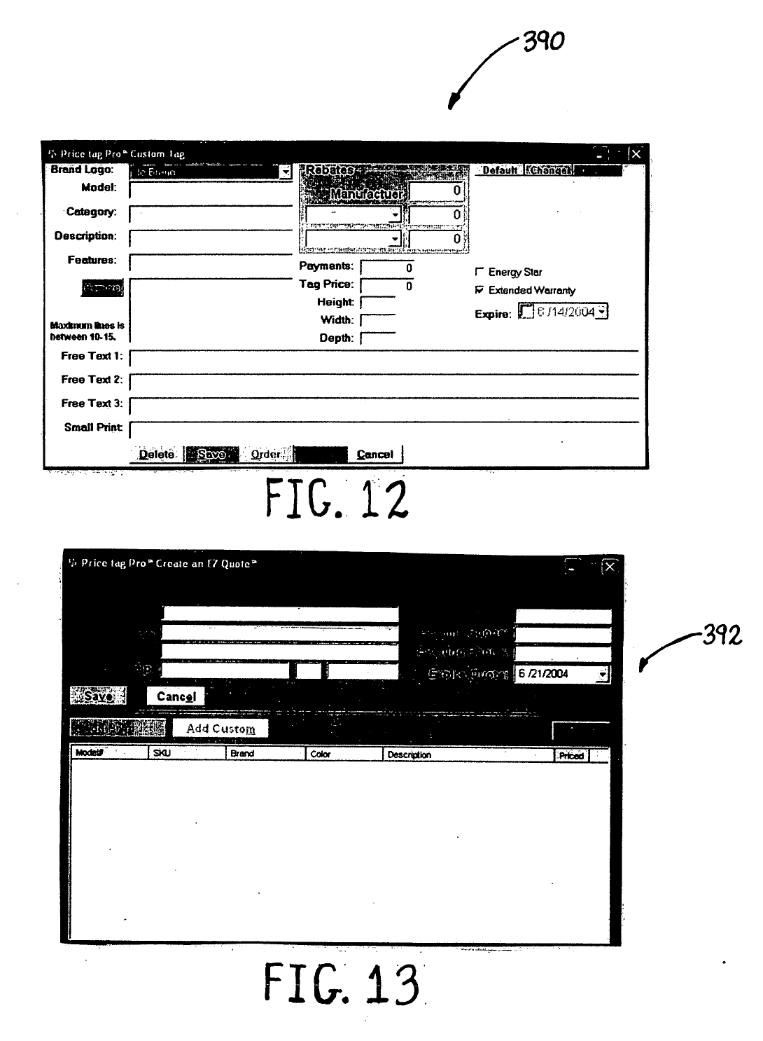

Referring to FIG. 13 there is shown an illustrative screenshot of the GUI for generating a customer quote for a plurality of the retailer's products. The customer quote is generated by first inputting the customer information. A plurality of the retailer's products are then listed. The quote is then printed out. The retailer's local database is updated with this customer quote. The retailer can access this customer quote to ensure clear communications with the customer.

Additionally, an order request system and method can be incorporated in the uniform price tag systems and methods described above. The order request system and method permits the retailer to order more products from the manufacturer. In operation, the order request system and method would connect to a manufacturer's web site and would automatically fill-in a manufacturer order request form. The order would be placed by the retailer in a manner that would prevent transcription errors because the product information is already locally stored on the retailer's database.

Furthermore, alternate embodiments of the invention which implement the systems in hardware, firmware, or a combination of both hardware and software, as well as distributing the modules and/or the data in a different fashion will be apparent to those skilled in the art and are also within the scope of the invention.

Although the description about contains many limitations in the specification, these should not be construed as limiting the scope of the claims but as merely providing illustrations of some of the presently preferred embodiments of this invention. Many other embodiments will be apparent to those of skill in the art upon reviewing the description. Thus, the scope of the invention should be determined by the appended claims, along with the full scope of equivalents to which such claims are entitled.

What is claimed is:

1. A personal computer configured to generate a uniform price tag for a retailer, comprising:
a memory having a searchable database stored thereon that receives product information, and retailer information;
a network connection configured to update said database with product information;
a processor operatively coupled to said memory, said processor configured to permit said retailer to search said database to select a product, and retrieve product information; and
a printer in operative communication with said processor, said printer configured to print said uniform price tag for said selected product, wherein said uniform price tag comprises product information and retailer information.

2. The personal computer of claim 1 wherein said retailer information comprises said retailer's name and address.

3. The personal computer of claim 1 further comprising a user interface that permits said retailer to select said product, and which permits said retailer to select a price for said product.

4. The personal computer of claim 1 wherein said uniform price tag comprises one or more rebates.

5. The personal computer of claim 1 wherein said uniform price tag comprises a product number that is correlated to a model number for said selected product, wherein said product number is displayed on said uniform price tag.

6. The personal computer of claim 1 wherein said uniform price tag comprises a display of a plurality of prices on said uniform price tag.

7. A method for generating a uniform price tag for a retailer, comprising:
causing said retailer to configure said retailer database by providing a plurality of retailer information;
causing said retailer database to be a searchable database having a plurality of product information;
updating said retailer database periodically;
permitting said retailer to select at least one product from said database; and
generating said uniform price tag by combining said product information with said retailer information on at least one label.

8. The method of claim 7 wherein said plurality of retailer information comprises said retailer's name and address.

9. The method of claim 8 wherein said plurality of retailer information comprises said retailer's logo.

10. The method of claim 7 further comprising permitting said retailer to select product information to include in said price tag.

11. The method of claim 7 wherein said generating of said uniform price tag further comprises having said retailer identify one or more rebates on said uniform price tag.

12. The method of claim 7 wherein said generating of said uniform price tag further comprises generating a product number that is correlated to a model number for said selected product, wherein said product number is displayed on said uniform price tag.

13. The method of claim 7 wherein said generating of said uniform price tag further comprises displaying a plurality of prices on said price tag.

14. A system configured to generate a uniform price tag for a retailer, comprising:
a server having a product database that receives a plurality of updated product information, said database having a network connection to the Internet;
a personal computer communicatively coupled to the Internet, said personal computer configured to store a plurality of retailer information and configured to permit said retailer to search said database to select a product, and retrieve product information; and
a printer in operative communication with said personal computer, said printer configured to print said uniform price tag for one or more selected products, wherein said uniform price tag comprises product information and retailer information.

15. The system claim 14 wherein said retailer information comprises said retailer's name and address.

16. The system of claim 14 wherein said personal computer further comprises a user interface that permits said retailer to select said one or more products, and which permits said retailer to select a price for said product.

17. The system of claim 14 wherein said uniform price tag comprises one or more rebates.

18. The system of claim 14 wherein said uniform price tag comprises a product number that is correlated to a model number for said selected product, wherein said product number is displayed on said uniform price tag.

19. The system of claim 14 wherein said uniform price tag comprises a display of a plurality of prices on said uniform price tag.
